(19) United States
(12) Patent Application Publication
(10) Pub. No.: US 2014/0201916 A1
(43) Pub. Date: Jul. 24, 2014

(54) ARTICULATING BED WITH SIMPLIFIED ACTUATION

(71) Applicant: ERGOMOTION, INC., Santa Barbatra, CA (US)

(72) Inventors: Joseph Ermalovich, Santa Barbara, CA (US); Joey Krueger, Santa Barbara, CA (US)

(73) Assignee: ERGOMOTION, INC., Santa Barbatra, CA (US)

(21) Appl. No.: 14/161,957

(22) Filed: Jan. 23, 2014

Related U.S. Application Data
(60) Provisional application No. 61/756,294, filed on Jan. 24, 2013.

(51) Int. Cl. A61G 7/018; A61G 7/05; A61G 7/015

(52) U.S. Cl. CPC A61G 7/018; A61G 7/015; A61G 7/0507
USPC 5/618; 5/617

(57) ABSTRACT

An articulating bed incorporates an actuation system which employs an actuator pivotally attached at a first end to a midpoint of a head end rail of a frame. The actuator has a range of motion from a retracted position to an extended position. A roller assembly is pivotally attached to a central lateral rail in the frame and has a spacer bar. A second end of the actuator is pivotally attached to a midpoint of the spacer bar. The roller assembly further has rollers engaging a lower surface of an upper body support section. The upper body support section is substantially horizontal with the actuator in said retracted position and urged by the rollers for angular rotation about an axis through the range of motion for the actuator to a raised position in the extended position.

### REFERENCES TO RELATED APPLICATIONS

This application claims priority of U.S. provisional application Ser. No. 61/756,294 filed on Jan. 24, 2013 entitled ARTICULATING BED WITH SIMPLIFIED ACTUATION, the disclosure of which is incorporated herein by reference.

### BACKGROUND

1. Field

This invention relates generally to the field of adjustable beds and more particularly to a structure for an articulating bed having linear actuators driving roller arms for body and thigh support adjustment.

2. Description of the Related Art

Articulating beds have long been used in hospital and healthcare facilities to allow positioning of a patient in a reclining position, sitting position, elevated leg position or combinations of these positions. General usage of articulating beds has been rapidly expanding due to the comfort and convenience available from adjusting the bed to desired positions for reading, general relaxation or sleeping.

The mechanical structure and drive mechanisms for such articulating beds must be able to support the weight of both a mattress and the occupant. Due to the size, weight, fabrication materials and configuration of the mattress and supporting structure, maintaining rigidity in the system may also be challenging. Typical articulating beds provide an upper body positioning element and a thigh and lower leg positioning element either individually active or with combined actuation. However, structural actuation of these elements has typically been complex.

It is therefore desirable to provide an articulating bed having upper body positioning and a thigh and lower leg positioning with simplified actuation elements.

### SUMMARY

The embodiments disclosed herein provide an actuation system for an articulating bed which employs an actuator pivotally attached at a first end to a midpoint of a head end rail of a frame. The actuator has a range of motion from a retracted position to an extended position. A roller assembly is pivotally attached to a central lateral rail in the frame and has a spacer bar. A second end of the actuator is pivotally attached to a midpoint of the spacer bar. The roller assembly further has rollers engaging a lower surface of an upper body support section. The upper body support section is substantially horizontal with the actuator in said retracted position and urged by the rollers for angular rotation about an axis through the range of motion for the actuator to a raised position in the extended position.

### BRIEF DESCRIPTION OF THE DRAWINGS

These and other features and advantages of the present invention will be better understood by reference to the following detailed description of exemplary embodiments when considered in connection with the accompanying drawings wherein:

FIG. 1 is a bottom pictorial view of an articulating bed system employing an example embodiment in a fully retracted or unarticulated position;

FIG. 2 is a bottom pictorial view of the articulating bed system of FIG. 1 with the upper body section and thigh support and lower leg section elevated;

FIG. 3 is a side view of the articulating bed system showing the actuation components unarticulated state;

FIG. 4 is a side view of the articulating bed system showing the actuation components articulated state.

### DETAILED DESCRIPTION

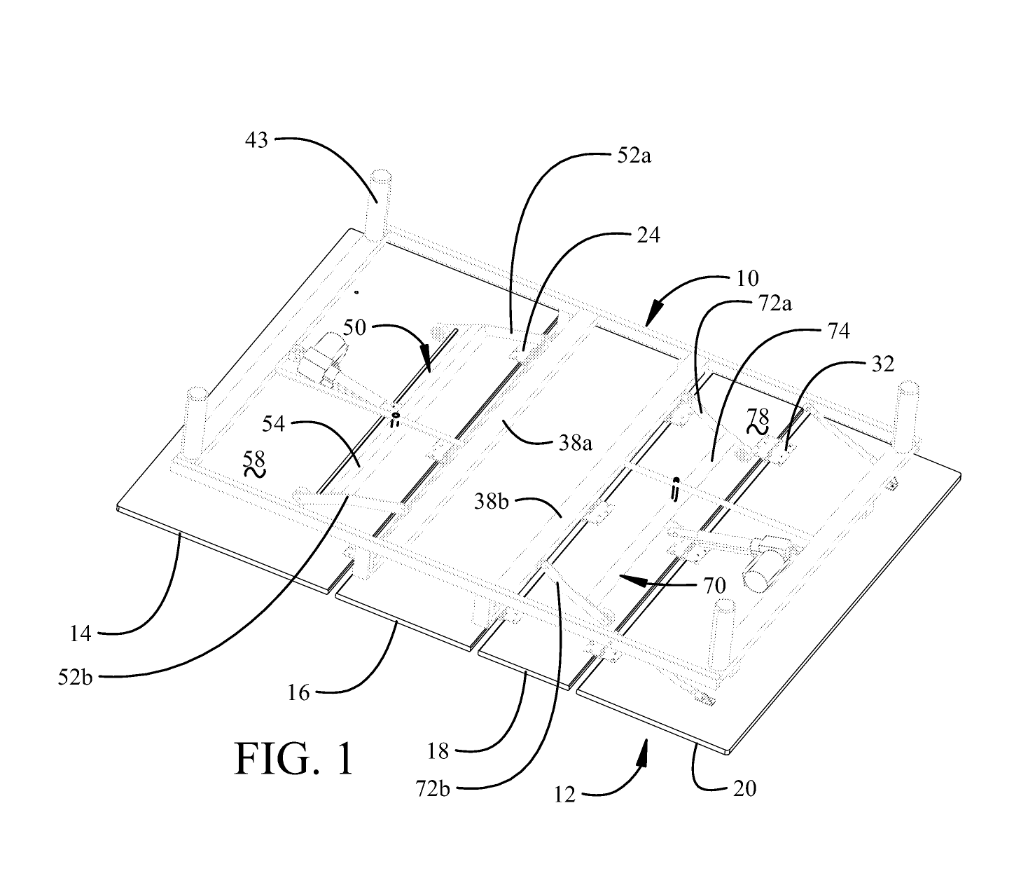

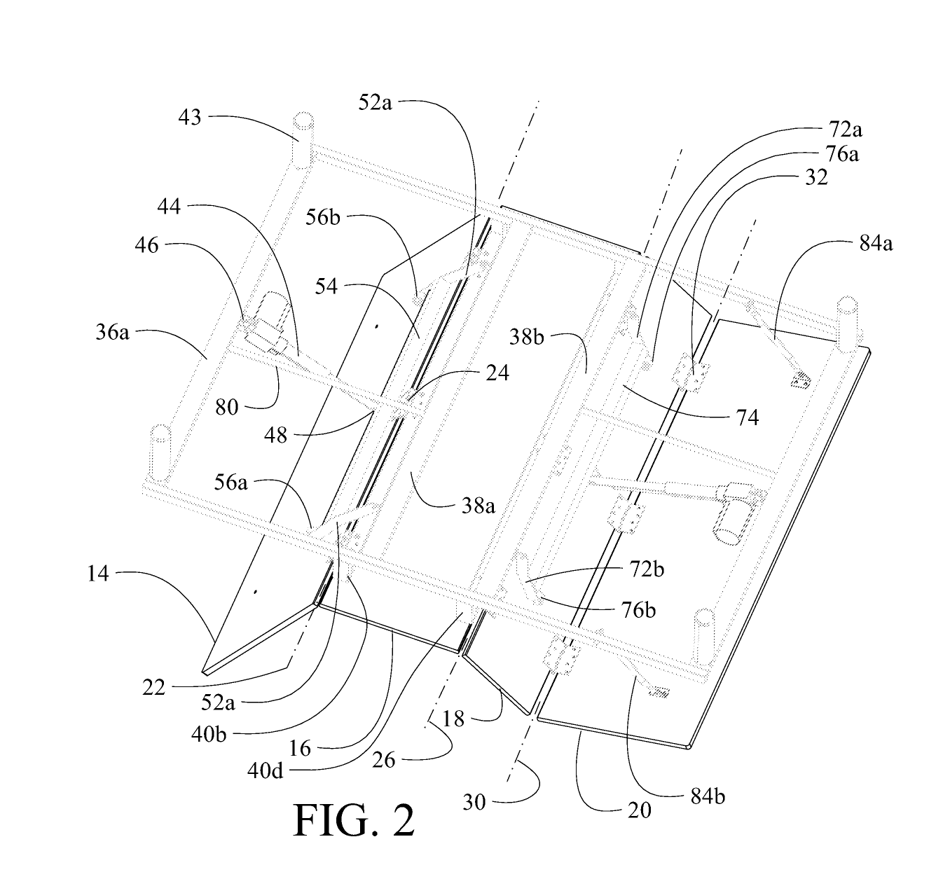

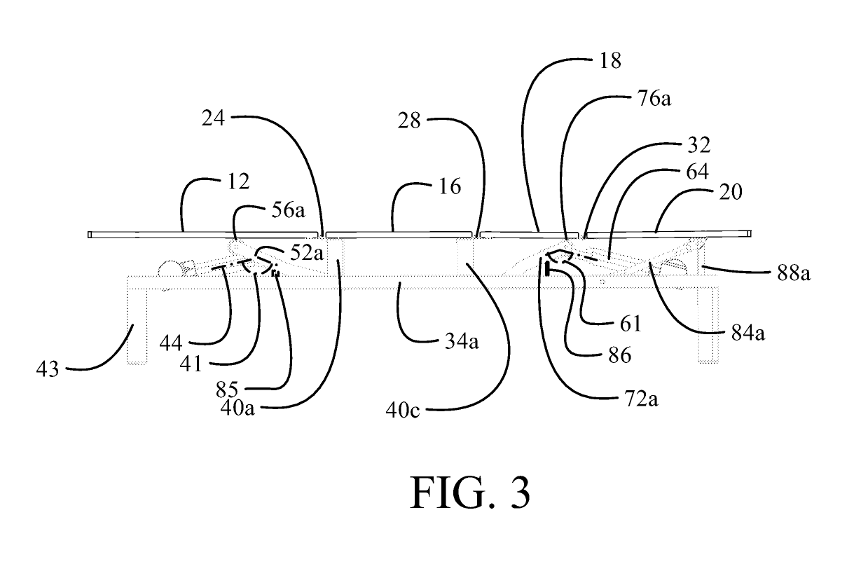

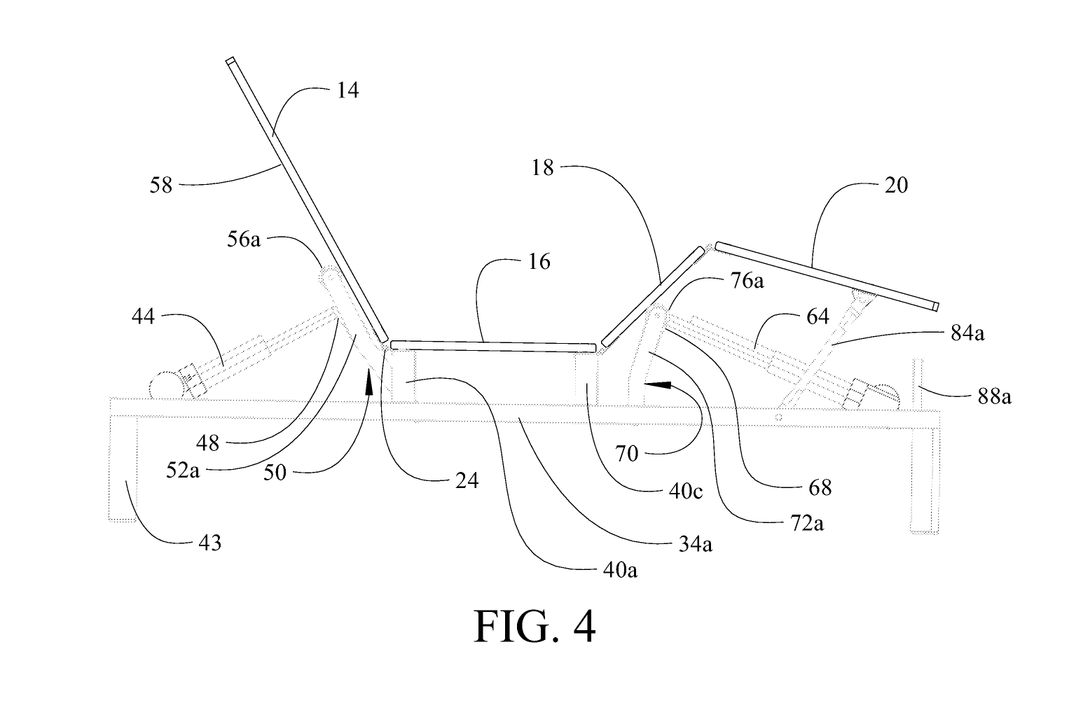

Embodiments shown in the drawings and described herein provide an actuation system for an articulating bed. As shown in FIGS. 1-4, the articulating bed incorporates a frame 10 upon which an articulating support system 12 is mounted. The articulating support system 12 incorporates an upper body section 14, a seat section 16, a thigh section 18 and a lower leg section 20. In a fully unarticulated position, as shown in FIGS. 1 and 3, the upper body section 14, seat section 16, thigh section 18 and lower leg section 20 are aligned in a planar relationship. In a fully articulated position, as shown in FIGS. 2 and 4, the upper body section 14 rotates about an articulation axis 22 extending through hinges 24 connecting the upper body section 14 to the seat section 16. The thigh section 18 rotates about a second articulation axis 26 extending through hinges 28 connecting the thigh section 16 to the seat section 16. Lower leg section 20 rotates about a third articulation axis 30 extending through hinges 32 connecting the lower leg section 20 to the thigh section 18. In alternative embodiments the seat section, thigh section and lower leg section may be included in a non-articulating support element with only the upper body section 14 articulating.

Frame 10 is substantially rectangular in shape with side rails 34a and 34b extending between a head end rail 36a and a foot end rail 36b. Central lateral rails 38a and 38b extend between the side rails 34a and 34b substantially equally spaced from the end rails. In alternative embodiments, a single central lateral rail may be employed 41 Articulating support system 12 is supported from the frame on vertical standoffs 40a, 40b, 40c and 40d extending upward from the side rails to engage the seat section 16 which may incorporate lateral supports 42a and 42b for additional rigidity. Legs 43 support the frame from the floor.

Articulation of the upper body support section 14 is accomplished with an actuator 44 having a first end 46 pivotally attached to the head end rail 36a substantially at a midpoint of the rail and a second end 48 pivotally attached to a roller assembly 50. The roller assembly 50, for the example embodiment, includes arms 52a and 52b pivotally attached at first ends 53a and 53b, respectively, to the central lateral rail 38a. Arms 52a and 52b are interconnected with spacer bar 54. Pivotal attachment of second end 48 of the actuator to the roller assembly 50 is accomplished substantially at a midpoint of the spacer bar 54. Arms 52a and 52b terminate in rollers 56a and 56b which engage a lower surface 58 of the upper body support section 14.

For the example embodiment, actuator 44 is a motor driven linear actuator having a range of motion from a retracted position as shown in FIGS. 1 and 3 to an extended position as shown in FIGS. 2 and 4. Extending the actuator 44 from the retracted position urges roller assembly 50 to rotate about the pivotal attachments to the central lateral rail 38a from a first angular position as shown in FIG. 3 to a second angular position as shown in FIG. 4. Standoffs 40a-40d space the articulating support system 12 from the frame 10 to allow a sufficient angle 41 (less than 180 degrees) between the actuator 44 and arms 52a, 52b of the roller assembly 50 to prevent an aligned condition that would prevent extension of the actuator. In example embodiments an angle of 168 degrees or less is desirable. In certain embodiments, depth of the frame rails may be sufficient to allow mounting of the actuator and roller assembly with sufficient relative angle to obviate the need for the standoffs. Rollers 56a and 56b acting on the bottom surface 58 of the upper body support section 14 rotate the upper body support section about axis 22 from a horizontal position shown in FIG. 3 to an angled position as shown in FIG. 4.

Articulation of the thigh section 18 is similar and is accomplished with a second actuator 64 having a first end 66 pivotally attached to the foot end rail 36b substantially at a midpoint between the side rails and a second end 68 pivotally attached to a second roller assembly 70. The second roller assembly 70, for the example embodiment, includes arms 72a and 72b pivotally attached at first ends 73a and 73b, respectively, to the central lateral rail 38b. Arms 72a and 72b are interconnected with spacer bar 74. Pivotal attachment of second end 68 of the actuator to the roller assembly 70 is accomplished substantially at a midpoint of the spacer bar 74. Arms 72a and 72b terminate in rollers 76a and 76b which engage a lower surface 78 of the thigh support section 18.

For the example embodiment, second actuator 64 is also a motor driven linear actuator having a range of motion from a retracted position as shown in FIGS. 1 and 3 to an extended position as shown in FIGS. 2 and 4. Extending the second actuator 64 from the retracted position urges second roller assembly 70 to rotate about the pivotal attachments to the central lateral rail 38b from a first angular position as shown in FIG. 3 to a second angular position as shown in FIG. 4. Standoffs 40a-40d space the articulating support system 12 from the frame 10 to allow a sufficient angle 61 (less than 180 degrees) between the second actuator 64 and arms 72a, 72b of the roller assembly 70 to prevent an aligned condition that would prevent extension of the actuator. In certain embodiments, depth of the frame rails may be sufficient to allow mounting of the second actuator and second roller assembly with sufficient relative angle to obviate the need for the standoffs. Rollers 76a and 76b acting on the bottom surface 78 of the thigh support section 18 rotate the thigh support section about axis 26 from a horizontal position shown in FIG. 3 to an angled position as shown in FIG. 4.

For operation of both the first and second actuator and associated first and second roller assemblies, additional force resolution to reduce potential bending within the frame while allowing lighter structural weight is accomplished using tension rods 80 and 82 extending between the head end rail 36a and central lateral support 38a and the foot end rail 36b and central lateral support 38b, respectively.

Articulation of the lower leg section 20 is accomplished with actuation of the thigh section 18. As the thigh section elevates, urged angularly about axis 26, lower leg section 20 rotates about axis 30 constrained in motion by positioning rods 84a and 84b which are pivotally attached to the side rails 34a and 34b, respectively, and a bottom surface 86 of the lower leg section 20. Additional support for the lower leg section 20 in the unactuated position as shown in FIG. 3 is provided by upstanding foot end spacers 88a and 88b. Similar head end spacers may be employed for the upper body section in the unactuated position. The spacers additionally prevent lowering of the lower leg section and the attached thigh section and the upper body section below the necessary angles 41 and 61 to prevent linear lock by the actuators as previously described. Additional spacers 85 and 86 located between tension rods 80 and 82 and spacer bars 54 and 74, respectively, may also be employed to prevent rotation into linear lock by the actuators.

The simplified structural arrangement of the present embodiments with actuators located substantially along a midline of the bed with roller assemblies providing rotational engagement of the support sections provides balanced operation of the actuation support system with minimal structural complexity.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. An actuation system for an articulating bed comprising:
an actuator pivotally attached at a first end to a midpoint of a head end rail of a frame, said actuator having a range of motion from a retracted position to an extended position;
a roller assembly pivotally attached to a central lateral rail in the frame and having a spacer bar, a second end of the actuator pivotally attached to a midpoint of the spacer bar, said roller assembly further having rollers engaging a lower surface of an upper body support section, said upper body support section substantially horizontal with the actuator in said retracted position and urged by the rollers for angular rotation about an axis through the range of motion for the actuator to a raised position in the extended position.

2. The actuation system as defined in claim 1 wherein the roller assembly comprises first and second arms having a pivotal attachment to the central lateral rail and opposite ends of the spacer bar, said rollers located at ends of the first and second arms distal from the pivotal attachment.

3. The actuation system as defined in claim 2 wherein the upper body support section is attached to a seat section with hinges forming the axis.

4. The actuation system as defined in claim 3 wherein the frame incorporates side rails and the seat section is mounted to the side rails with spacers, said actuator and said first and second arms forming a first angle less than 180 degrees in the retracted position and a second angle in the extended position.

5. The actuation system as defined in claim 1 further comprising:
a second actuator pivotally attached at a first end to a midpoint of a foot end rail of the frame, said second actuator having a range of motion from a retracted position to an extended position;
a second roller assembly pivotally attached to a central lateral rail in the frame and having a spacer bar, a second end of the second actuator pivotally attached to a midpoint of the spacer bar, said roller assembly further having rollers engaging a lower surface of a thigh support section, said thigh support section substantially horizontal with the actuator in said retracted position and urged by the rollers for angular rotation about a second axis through the range of motion for the second actuator to a raised position in the extended position.

6. The actuation system as defined in claim 5 wherein the second roller assembly comprises third and fourth arms having a pivotal attachment to the central lateral rail and opposite ends of the second spacer bar, said rollers located at ends of the third and fourth arms distal from the pivotal attachment.

7. The actuation system as defined in claim 6 wherein the thigh support section is attached to a seat section with hinges forming the second axis.

8. The actuation system as defined in claim 7 wherein the frame incorporates side rails and the seat section is mounted to the side rails with spacers, said second actuator and said third and fourth arms forming a first angle less than 180 degrees in the retracted position and a second angle in the extended position.

9. The actuation system as defined in claim 1 further comprising a first tension rod connected between the head end rail and the central lateral rail.

10. The actuation system as defined in claim 1 further comprising a second tension rod connected between the foot end rail and the central lateral rail.

11. An articulating bed system comprising:
a frame having side rails, a head end rail, a foot end rail and at least one central lateral rail;
an articulating support system having an upper body support section and a seat section mounted to said frame, said upper body support section attached to the seat section with hinges for rotation about an axis;
an actuator pivotally attached at a first end to a midpoint of the head end rail, said actuator having a range of motion from a retracted position to an extended position;
a roller assembly pivotally attached to the at least one central lateral rail in the frame and having a spacer bar, a second end of the actuator pivotally attached to a midpoint of the spacer bar, said roller assembly further having rollers engaging a lower surface of an upper body support section, said upper body support section substantially horizontal with the actuator in said retracted position and urged by the rollers for angular rotation about the axis through the range of motion for the actuator to a raised position in the extended position.

12. The articulating bed system as defined in claim 1 wherein the roller assembly comprises first and second arms having a pivotal attachment to the central lateral rail and opposite ends of the spacer bar, said rollers located at ends of the first and second arms distal from the pivotal attachment.

13. The articulating bed system as defined in claim 12 wherein the upper body support section is attached to a seat section with hinges forming the axis.

14. The articulating bed system as defined in claim 13 wherein the frame incorporates side rails and the seat section is mounted to the side rails with spacers, said actuator and said first and second arms forming a first angle less than 180 degrees in the retracted position and a second angle in the extended position.

15. The articulating bed system as defined in claim 11 further comprising:
a second actuator pivotally attached at a first end to a midpoint of the foot end rail of the frame, said second actuator having a range of motion from a retracted position to an extended position;
a second roller assembly pivotally attached to the at least one central lateral rail in the frame and having a spacer bar, a second end of the second actuator pivotally attached to a midpoint of the spacer bar, said roller assembly further having rollers engaging a lower surface of a thigh support section in the articulating support system, said thigh support section substantially horizontal with the actuator in said retracted position and urged by the rollers for angular rotation about a second axis through the range of motion for the second actuator to a raised position in the extended position.

16. The articulating bed system as defined in claim 15 wherein the second roller assembly comprises third and fourth arms having a pivotal attachment to the central lateral rail and opposite ends of the second spacer bar, said rollers located at ends of the third and fourth arms distal from the pivotal attachment.

17. The articulating bed system as defined in claim 16 wherein the thigh support section is attached to a seat section with hinges forming the second axis.

18. The articulating bed system as defined in claim 17 wherein the seat section is mounted to the side rails with spacers, said second actuator and said third and fourth arms forming a first angle less than 180 degrees in the retracted position and a second angle in the extended position.

19. The articulating bed system as defined in claim 11 further comprising a first tension rod connected between the head end rail and the central lateral rail.

20. The articulating bed system as defined in claim 11 further comprising a second tension rod connected between the foot end rail and the central lateral rail.
